(19) United States
(12) Patent Application Publication
(10) Pub. No.: US 2007/0062447 A1
(43) Pub. Date: Mar. 22, 2007

(54) Film measuring device and method, coater equipped with film measuring device, and coating method using film measuring method

(76) Inventors: Tetsuya Hayashi, Osaka (JP); Masato Fujikawa, Osaka (JP); Kazutaka Teramoto, Osaka (JP)

Correspondence Address: MCDERMOTT WILL & EMERY LLP, 600 13TH STREET, N.W., WASHINGTON, DC, 20005-3096, US

(21) Appl. No.: 11/507,620

(22) Filed: Aug. 22, 2006

(30) Foreign Application Priority Data
Sep. 2, 2005 (JP) 2005-254331

(51) Int. Cl. B05C 11/00; B05C 1/00

(52) U.S. Cl. 118/713; 118/712; 118/231

(57) ABSTRACT

Provided is a film measuring device capable of accurately and easily measuring the thickness of a film formed on a film-like or sheet-like base member of an object under test. A color CCD sensor 8 shoots the object under test. A video board 11 converts a color tone of a color image signal concerning the film obtained by the image pickup into gradation data of respective color components of RGB. Then, an image processing board 12 extracts line images of the respective color components. A calculator 14 obtains the thickness of the film of the object under test by referring to pre-measured film thickness reference values corresponding to the gradation data of the green or blue color component, which are stored in a table storage 13 as reference thickness table data, using the gradation data of the line image of the green or blue color component as lookup data.

### BACKGROUND OF THE INVENTION

1. Field of the Invention

The present invention relates to a device and a method for measuring a thickness and a weight per unit area of a film formed on a film-like or sheet-like base member, as well as a coater equipped with the film measuring device, and a coating method using the film measuring method.

2. Description of the Related Art

Heretofore, there has been used a technique of measuring the weight per unit area of a film formed on a spirally wound electrode plate for use in an alkaline secondary battery or a lithium ion secondary battery, as disclosed in Japanese Laid-Open Patent Publication No. H8(1996)-96806 (D1), for instance. In D1, a β-ray emitter and a detector are arranged as opposed to each other, with a film to be measured being fed in a certain direction between the β-ray emitter and the detector. The β-ray emitter and the detector are moved in cooperation with each other in a width direction of the film to be measured, i.e. in a direction orthogonal to the feeding direction of the film. During the movements of the β-ray emitter and the detector, the β-ray emitter emits β-rays, and the detector detects the amount of the β-rays transmitted through the film to be measured. The weight per unit area of the film is measured by comparing a detection result on the β-ray transmission with a reference transmission amount.

In the above arrangement, the measurement sites are only the positions where the β-ray emitter and the detector are moved, and accordingly, it is impossible to conduct the measurement for the entire area of the film to be measured. Also, it is hazardous to handle β-rays. The installation condition for the β-ray emitter is constrained because a radioactive ray is used. Further, a qualified staff is required to operate the β-ray emitter, which hinders usability of the β-ray emitter. In addition, the β-ray emitter is expensive. Furthermore, in the case where the thickness of a film formed on a base film is to be measured, a β-ray transmission amount is varied due to a thickness variation of the base film, which makes it impossible to accurately measure the thickness of the film formed on the base film. Accordingly, restrictions on selection of the material for the base film is imposed.

Also, if a base member is a metallic thick plate, and a film to be coated on the metallic thick plate is a resin paint as in the case of coating for an automotive steel sheet, measurement of the film thickness itself with use of β rays may be difficult.

Japanese Laid-Open Patent Publication No. H8(1996) -309262 (D2) proposes a film thickness measuring device constructed such that: a UV ray is irradiated onto a surface of a golf ball coated with a clear coat made of a clear coating material containing a fluorescent brightening agent; secondary emission rays obtained by the UV ray irradiation are captured by a CCD camera; a contrast image is obtained by multilevel-processing the acquired image data; and the thickness of the coat is measured based on the contrast image.

It is, however, impossible to measure the film thickness, unless the film has a property responsive to a specific wavelength, even by modifying the art recited in D2 so as to measure the thickness of the film formed on the film-like or sheet-like base member.

### SUMMARY OF THE INVENTION

In view of the above problems residing in the conventional examples, it is an object of the present invention to provide a film measuring device and method capable of accurately and easily measuring a physical amount of a film formed on a film-like or sheet-like base member, as well as a coater equipped with the film measuring device, and a coating method using the film measuring method.

An aspect of the present invention is directed to a film measuring device for measuring a physical amount of a film formed on a film-like or sheet-like base member of an object under test. The device includes: an image pickup section for converting a color tone of a color image of the film obtained by shooting the object under test into gradation data of respective color components; a table storage for storing therein pre-measured reference values of a physical amount of the film corresponding to gradation levels of at least one of the color components in the form of a table; and a calculator for obtaining the physical amount of the film of the object under test by referring to the reference values of the physical amount stored in the table storage, using, as lookup data, the gradation data of the at least one color component among the gradation data of the respective color components obtained by the image pickup section.

Another aspect of the present invention is directed to a coater including: the aforementioned film measuring device; a coating section for forming the film on the base member; and a coating amount controller for controlling a coating amount for the film in the coating section in accordance with the thickness of the film obtained by the calculator of the film measuring device.

Yet another aspect of the present invention is directed to a film measuring method for measuring a physical amount of a film formed on a film-like or sheet-like base member of an object under test. The method includes steps of: converting a color tone of a color image of the film obtained by shooting the object under test into gradation data of respective color components; and obtaining a physical amount of the film of the object under test by referring to pre-measured reference values of the physical amount of the film of the object under test corresponding to the gradation data of at least one of the color components obtained in the conversion step, using the gradation data of the at least one color component as lookup data, the reference values being stored as table data.

Still another aspect of the present invention is directed to a coating method using the aforementioned film measuring method. The coating method includes steps of: coating the film on the base member; and controlling a coating amount for the film in the coating step in accordance with the physical amount of the film obtained by the film measuring method.

These and other objects, features and advantages of the present invention will become more apparent upon reading the following detailed description along with the accompanying drawing.

### BRIEF DESCRIPTION OF THE DRAWING

FIG. 1 is a diagram showing an entire configuration of a coater equipped with a film measuring device in an embodiment of the invention.

FIG. 2 is a graph showing relationships between thickness of a titanium oxide layer, and gradation levels of respective color components of red (R), green (G), and blue (B) in the case where the titanium oxide layer is formed on a copper foil.

FIG. 3 is a graph showing relationships between thickness of an alumina layer, and gradation levels of respective color components of RGB in the case where the alumina layer is formed on a mixture layer formed by coating a carbon material on a copper foil.

FIG. 4 is a graph showing relationships between thickness of a titanium oxide layer, and gradation level of color component B in the case where the titanium oxide layer is formed on a copper foil.

FIG. 5 is a graph showing relationships between thickness of an alumina layer, and gradation level of color component B in the case where the alumina layer is formed on a mixture layer formed by coating a carbon material on a copper foil.

FIG. 6A is a graph showing relationships between thickness of blue ink, and gradation levels of respective color components of RGB in the case where the blue ink is coated on a matte black finished mixture layer.

FIG. 6B is a graph showing relationships between thickness of red ink, and gradation levels of respective color components of RGB in the case where the red ink is coated on a matte black finished mixture layer.

FIG. 6C is a graph showing relationships between thickness of green ink, and gradation levels of respective color components of RGB in the case where the green ink is coated on a matte black finished mixture layer.

FIG. 6D is a graph showing relationships between thickness of aqua color ink, and gradation levels of respective color components of RGB in the case where the aqua color ink is coated on a matte black finished mixture layer.

FIG. 6E is a graph showing relationships between thickness of pink color ink, and gradation levels of respective color components of RGB in the case where the pink color ink is coated on a matte black finished mixture layer.

### DETAILED DESCRIPTION OF THE PREFERRED EMBODIMENTS

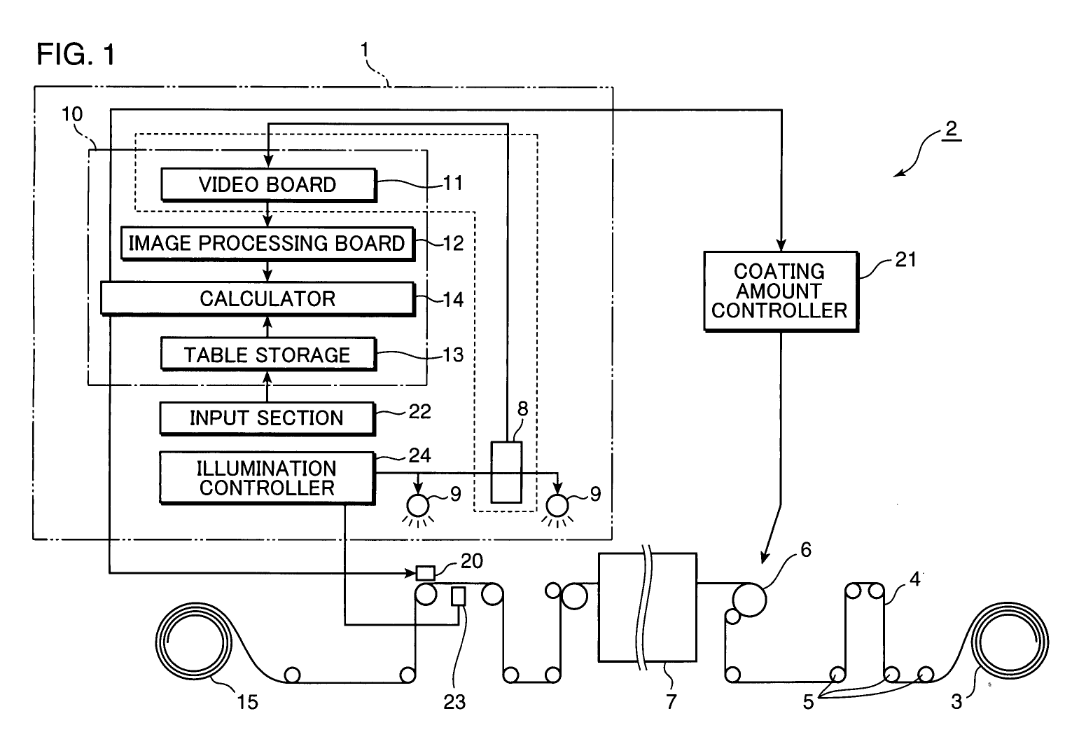

FIG. 1 is a diagram showing an entire configuration of a coater 2 using a film measuring device 1 according to a preferred embodiment of the present invention. The film measuring device 1 is adapted for measuring, as physical amounts of a film formed on a film-like or sheet-like base member of an object under test, the thickness and the weight per unit area of the film. The following description is made for a case where a ceramic protected metal sheet is used as an example of the object under test. An arrangement and an operation of the embodiment are illustrated and described for a case that the thickness of a microporous ceramic film formed on the metal sheet is measured. In this embodiment, a coater 2 is adapted to form a titanium oxide film on a copper foil.

A copper plate 4 as the object under test has a sheet-like shape, and is spirally wound in the form of a roll 3. Hereinafter, the copper plate is called as “copper sheet 4”. The copper sheet 4 is sequentially dispensed and fed through a plurality of guide rollers 5, so that a titanium oxide paint is coated on the copper sheet 4 by a coating section 6. After the coating, the copper sheet 4 is guided to a drying furnace 7 where the paint coated on the copper sheet 4 is dried. The film measuring device 1 is disposed at an outlet of the drying furnace 7.

In the film measuring device 1, a color CCD sensor 8 and an illumination light source 9 are disposed on the side corresponding to the surface of the copper sheet 4 where the titanium oxide paint is coated. Immediately at a downstream of a position where the copper sheet 4 comes out of the drying furnace 7, the illumination light source 9 illuminates the copper sheet 4, and the color CCD sensor 8 sequentially captures images of the titanium oxide coated film on the copper sheet 4 on an area over the entire width of the copper sheet 4. The color CCD sensor 8 may include plural sensing devices arrayed in a line in such a manner that the sensing devices capture images of the titanium oxide film on an area substantially covering the entire width of the copper sheet 4. The illumination light source 9 is a straight tube-shaped fluorescent lamp so that an area along the entire width of the copper sheet 4 can be uniformly irradiated. In the case where ambient light of a sufficient light amount with less external stray light is obtained at the image capturing positions of the color CCD sensor 8, the illumination light source 9 may be omitted.

A color image signal outputted from the color CCD sensor 8 is sent to an image controller 10. Then, a video board 11 in the image controller 10 sequentially converts the input signal, i.e., a composite video signal obtained by superimposing a carrier chrominance signal to a luminance signal into primary color signals of red (R), green (G), and blue (B) of e.g. 8 bits, i.e. 256 gradation data. The color CCD sensor 8 and the video board 11 constitute an image pickup section.

An image processing board 12 in the image controller 10 extracts line images in the width direction of the copper sheet 4 based on the respective primary color signals of RGB. It is effective to use the green color component or the blue color component in order to measure the thickness of the titanium oxide film. In view of this, a table storage 13 stores therein pre-measured reference values of film thickness corresponding to the respective gradation levels of the green color component or the blue color component in the form of a reference thickness table. The effectiveness of the green color component or the blue color component will be described later.

A calculator 14 reads out a film thickness corresponding to a targeted gradation level by referring to the film thickness reference values stored in the table storage 13, and by using the gradation data concerning the green color component or the blue color component of the respective line images acquired by the image processing board 12, as lookup data. In the case where it is judged that there is no film thickness data corresponding to the targeted gradation level in the table storage 13, the calculator 14 obtains film thickness data corresponding to the targeted gradation level, using various approaches such as approximation or data interpolation for a film thickness characteristic with respect to the targeted gradation level, according to needs. Comparison in the calculator 14 between the measured value and the reference value in gradation level may be carried out in the unit of pixels, or may be made by dividing the captured image into predetermined number of areas, and by calculating an average in each of the areas.

The calculator 14 judges whether the thickness of the titanium oxide film lies within an allowable range relative to a predetermined reference value. If the calculator 14 judges that the film thickness lies out of the allowable range, the calculator 14 judges that the ceramic protected metal sheet carrying the titanium oxide film as a defective sheet. Then, the calculator 14 issues a marking signal to a marker 20 so that a defective area on the titanium oxide film is identified. In this case, even if the film thickness lies out of the allowable range in the order of several square centimeters (cm²) on an area of the ceramic protected metal sheet, in an actual process, an area on the metal sheet in the order of several square meters (m²) is required to be removed as a defective area. In view of this, the calculator 14 detects a predetermined area on the titanium oxide film including the area where the film thickness is judged to lie out of the allowable range, as a defective area.

After the test on the thickness of the titanium oxide film is conducted, the copper sheet 4 is wound into a roll 15.

The table storage 13 stores therein data relating to the weight per unit area of titanium oxide, which is a material for the film, in relation to the respective gradation levels of the green color component or the blue color component in the form of a reference weight table, as well as the data relating to the measured values of the film thickness corresponding to the respective gradation levels of the green color component or the blue color component. By the storage of the tables, the calculator 14 is allowed to calculate the thickness and the weight per unit area of the titanium oxide film.

Also, the calculator 14 outputs a correction signal to a coating amount controller 21 so that the calculated film thickness coincides with a predetermined reference value. The coating amount controller 21 controls the coater 6 to make a coating amount constant by changing a coating condition in response to the correction signal. Specifically, in case of using a die coater, a rotational speed of a pump is changed to control the coating amount. In case of using a gravure coater, a coating speed ratio is changed to control the coating amount. Thus, feedback control is performed to attain a constant thickness for the titanium oxide film.

An input section 22 is connected to the table storage 13. After the film thickness of the copper sheet 4 is measured, and the copper sheet 4 is withdrawn from the film forming process, an operator is allowed, using the input section 22, to input data obtained by actually measuring the thickness and the weight per unit area of the titanium oxide film for storage into the table storage 13. In this way, by allowing the operator to input the table data by way of the input section 22, a calibration curve concerning a relationship between gradation levels of the respective color components and the coating amount can be corrected, or the number of sampling data can be increased. Thus, measurement precision on the thickness and the weight per unit area of the film can be enhanced.

An illuminance sensor 23 is disposed on the side opposite to the color CCD sensor 8 and the illumination light source 9 with respect to the copper sheet 4. The illuminance sensor 23 measures the illuminance of the illumination light source 9 when transport of the copper sheet 4 is suspended, for instance, at the time of exchanging the roll 3, 15. Alternatively, the illuminance sensor 23 may be disposed outside of an end of the copper sheet 4 so that the illuminance of the illumination light source 9 is constantly measured. In such a case, feedback control is performed so that an illumination controller 24 controllably keeps the illuminance of the illumination light source 9 constant based on a measurement result by the illuminance sensor 23. With this arrangement, the illuminance of illumination light can be maintained constant, despite aging degradation of the illumination light source 9 or fluctuation of a power source voltage, thereby enabling accurate film thickness measurement.

The above configuration realizes the coater 2 capable of accurately and easily measuring the thickness and the weight per unit area of a film coated on the copper sheet, and easily controlling the film forming process. Also, selecting at least one color component which is effective in film thickness measurement enables to measure the thickness and the weight per unit area of a film made of an intended material. Further, the thickness and the weight per unit area of the film over the entire area thereof can be measured by changing the image pickup position, or by providing the image pickup position for the entire area of the object under test.

The color component to be stored in the table storage 13 may be a color component that has a large contrast relative to the base member, and has a relatively large change in gradation level in estimated variation ranges for the thickness and the weight per unit area of the film. A monochromatic color component may be used. Alternatively, combination of plural color components may be used in the case where the plural color components show a remarkable change between plural regions within the aforementioned variation ranges. Further alternatively, the color component may be in the form of a composite signal obtained by combining a color-difference signal to a luminance signal, in place of the signals respectively representing the individual color components of RGB, or cyan (C), magenta (M), and yellow (Y).

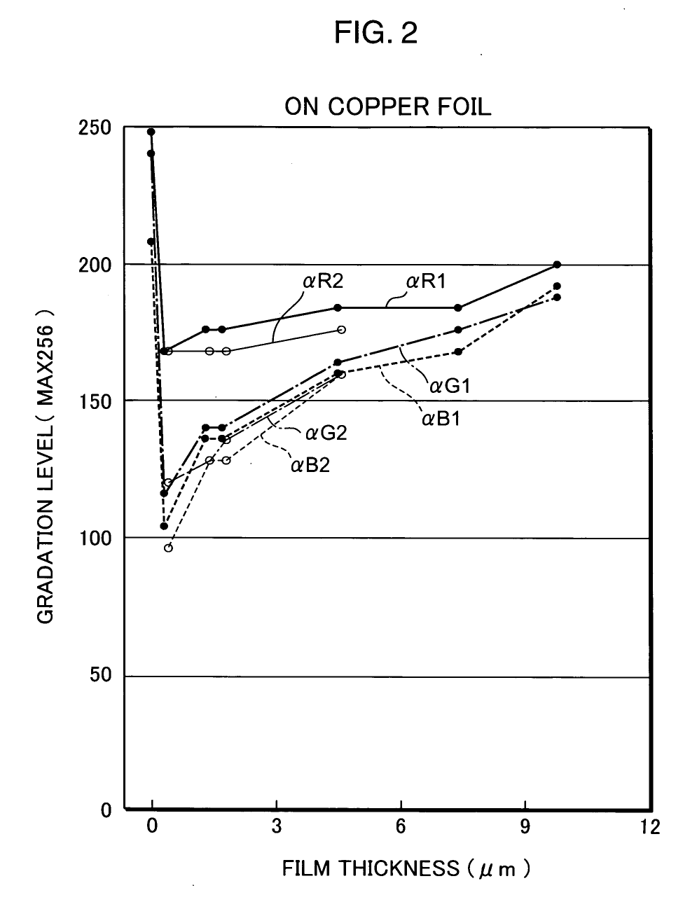

FIG. 2 is a graph showing relationships between thickness of a titanium oxide layer, and gradation levels of the respective color components of RGB, in the case where a titanium oxide paint containing titanium oxide as an inorganic oxide filler, and a binder is coated on a copper foil as a base member.

In the above arrangement, the white powdery titanium oxide paint is coated on the metallic color copper foil. Referring to FIG. 2, first sampling data are denoted by reference numerals αR1, αG1, and αB1; and second sampling data are denoted by reference numerals αR2, αG2, and αB2.

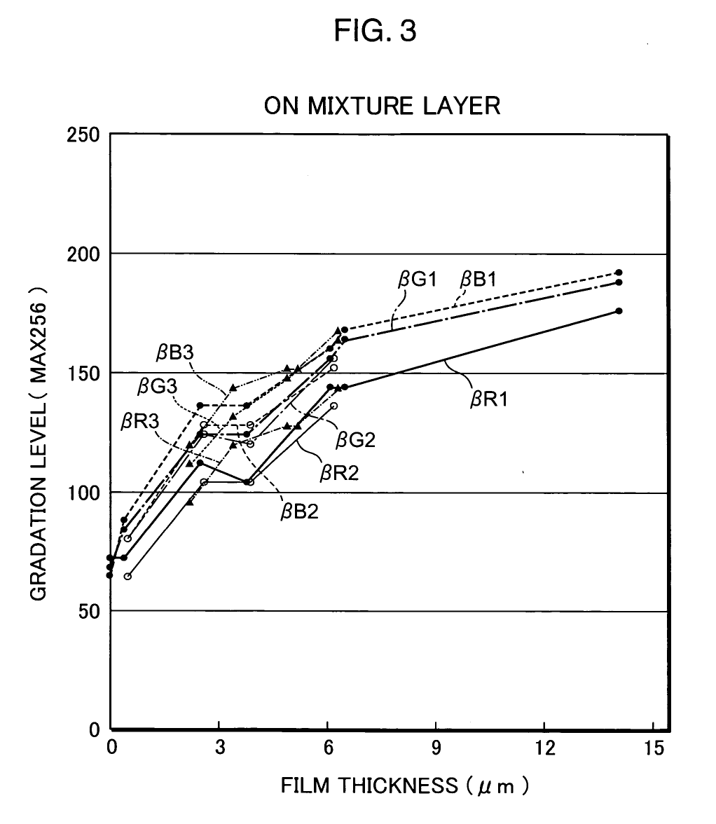

FIG. 3 is a graph showing relationships between thickness of an alumina layer, and gradation levels of the respective color components of RGB. Specifically, a mixture paste containing a carbon material is coated on a copper foil as a base member to form a mixture layer, and then, an alumina paint containing alumina as an inorganic oxide filler, and a binder is coated on the mixture layer.

In this case, the white powdery alumina paint is coated on the matte black finished mixture layer. Referring to FIG. 3, first sampling data are denoted by reference numerals βR1, βG1, and βB1; and second sampling data are denoted by reference numerals βR2, βG2, and βB2. Third sampling data denoted by reference numerals βR3, βG3, and βB3 are measurement data in which the viscosity of the alumina paint is changed by changing the composition ratio of the binder relative to the alumina. Specifically, a mixture paste with a density of 1.63 g/cm³ is coated on a copper foil of 16 μm in thickness so that the thickness of the mixture layer on one surface of the copper foil is 100 μm. Then, an alumina paint in NMP (N-methyl-2-pyrrolidone) solution, with a solid content ratio of 45% and a composition ratio of alumina to PVDF (polyvinylidene fluoride) at 96:4, is coated on the mixture layer.

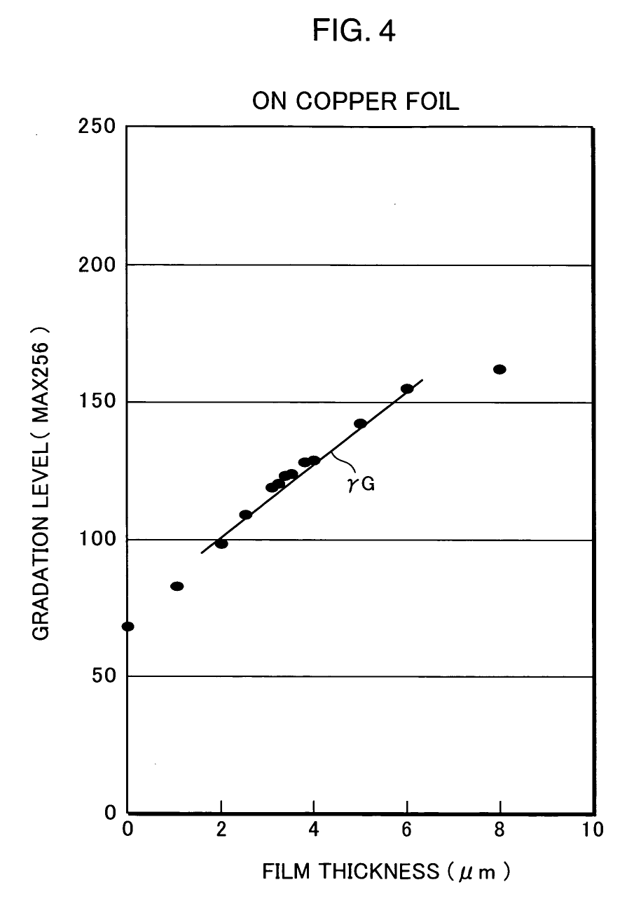

As is obvious from FIG. 2, as compared with the red color components (αR1, αR2), the green and blue color components (αG1, βB1; αG2, βB2) show greater changes in gradation level relative to the same variation amounts in film thickness, which shows that the green and blue color components are advantageous in film thickness measurement. Between the green and blue color components, the green color component (αG1) has a superior linear characteristic. In view of this, the green color component is used for film thickness measurement in the case where a titanium oxide paint is coated on a copper foil. FIG. 4 and Table 1 respectively show a graph and data concerning a relationship between film thickness and gradation level of the green color component, which is extracted from the graph in FIG. 2. In film thickness measurement, the film thickness can be calculated by data interpolation for a targeted gradation level, using the straight line represented by the reference numeral γG in FIG. 4.

TABLE 1
on mixture layer surface

| | gradation of green |
|---|---|
| thickness (μm) | color component |
| 0 | 68 |
| 1.0 | 83 |
| 2.0 | 98 |
| 2.5 | 109 |
| 3.1 | 119 |
| 3.2 | 120 |
| 3.4 | 123 |
| 3.5 | 124 |
| 3.8 | 128 |
| 4.0 | 129 |
| 4.5 | 135 |
| 5.0 | 142 |
| 6.0 | 155 |
| 8.0 | 162 |

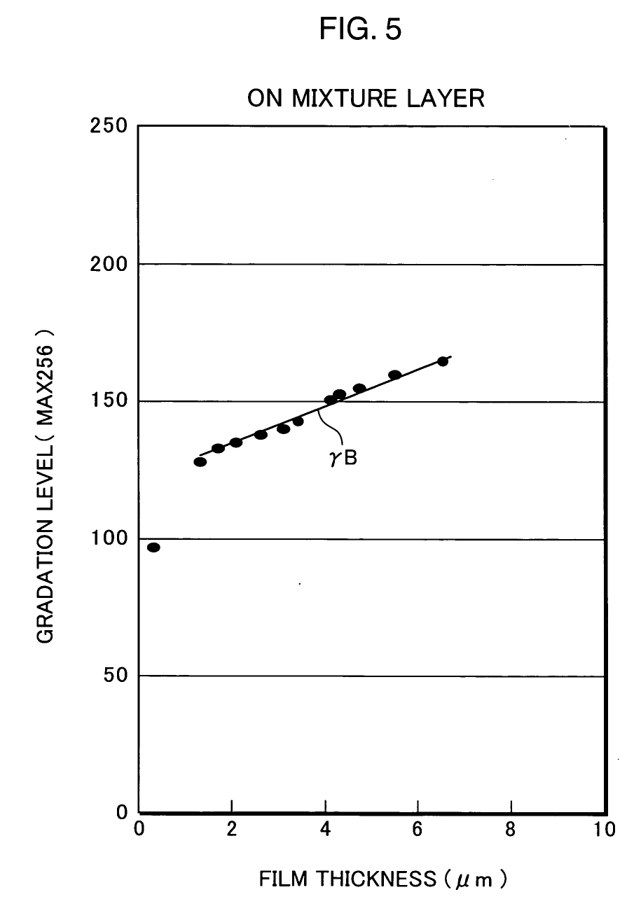

As is obvious from FIG. 3, changes in gradation level among the respective color components of RGB are substantially the same. This shows that use of any color component among the three color components is acceptable. Also, measurement precision can be enhanced by combining the color components. FIG. 5 and Table 2 respectively show a graph and data concerning a relationship between film thickness and gradation level of the blue color component, which is extracted from the graph in FIG. 3. The film thickness can be calculated by data interpolation for a targeted gradation level, using the straight line represented by the reference numeral γB in FIG. 5.

TABLE 2
on base member

| | gradation of blue |
|---|---|
| thickness (μm) | color component |
| 0.3 | 97 |
| 1.3 | 128 |
| 1.7 | 133 |
| 2.5 | 134 |
| 3.0 | 135 |
| 3.7 | 138 |
| 4.0 | 140 |
| 4.2 | 143 |
| 4.5 | 151 |
| 4.8 | 153 |
| 5.0 | 155 |
| 5.5 | 160 |
| 6.5 | 165 |

As shown in FIGS. 4 and 5, it is possible to recognize a thickness variation in the order of 1 μm, as a gradation level change in the gradation range from 0 to 256. Titanium oxide and magnesia show substantially the same gradation level changes as the alumina used as the inorganic oxide filler in the embodiment.

The film measuring device 1 in the embodiment not only measures the thickness and the weight per unit area of the titanium oxide layer and the alumina layer, but also is capable of measuring a semitransparent film whose color tone is varied depending on the film thickness. In the embodiment, the base member is a copper foil, or a mixture layer formed by coating a carbon material on a copper foil, which has a light blocking effect. In the case where the base member is made of a semitransparent material, a background member having a contrast relative to the film to be coated may be provided on the side opposite to the color CCD sensor 8 with respect to the copper sheet 4.

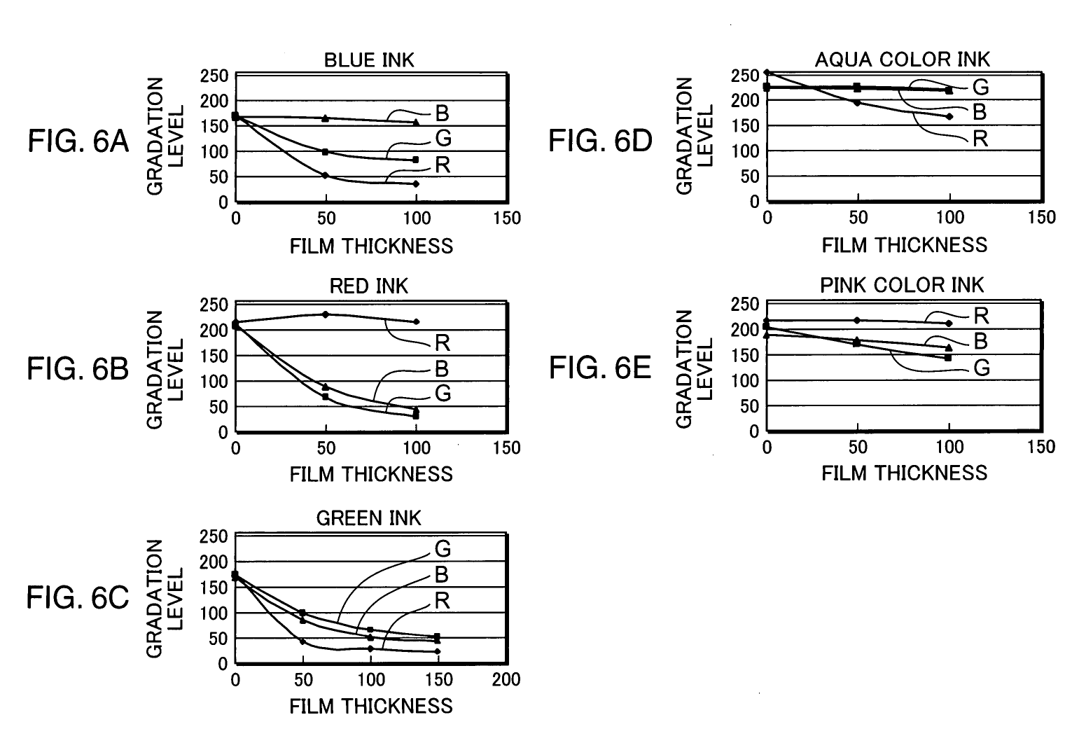

FIGS. 6A, 6B, 6C, 6D, and 6E are graphs each showing relationships between ink thickness, and gradation levels of the respective color components of RGB in the case where ink of a certain color is coated on a matte black finished mixture layer. FIG. 6A shows a case that blue ink is coated, FIG. 6B shows a case that red ink is coated, FIG. 6C shows a case that green ink is coated, FIG. 6D shows a case that aqua color ink is coated, and FIG. 6E shows a case that pink color ink is coated.

The following is an analysis result on FIGS. 6A through 6E. Since a thickness variation relative to the gradation level of the red color component is great in the case where the blue ink, the green ink, and the aqua color ink are coated, it is comprehended that use of the red color component is effective for the blue ink, the green ink, and the aqua color ink. Since a thickness variation relative to the gradation level of the green color component is great in the case where the red ink and the pink color ink are coated, it is comprehended that use of the green color component is effective for the red ink and the pink color ink. The above clarifies that the thickness of a film made of an intended material can be measured, using at least color component of the captured color image.

The following is a summary on the features of the invention.

A film measuring device according to a first aspect of the present invention is a device for measuring the thickness of a film formed on a film-like or sheet-like base member of an object under test. The device includes: an image pickup section for converting a color tone of a color image of the film obtained by shooting the object under test into gradation data of respective color components; a reference thickness table storage for storing therein pre-measured reference values of the film thickness corresponding to gradation levels of at least one of the color components in the form of a table; and a calculator for obtaining a thickness of the film of the object under test by referring to the film thickness reference values stored in the reference thickness table storage, using the gradation data of the at least one color component, as lookup data, among the gradation data of the respective color components obtained by the image pickup section.

A film measuring device according to a second aspect of the present invention is a device for measuring the weight per unit of a film formed on a film-like or sheet-like base member of an object under test. The device includes: an image pickup section for converting a color tone of a color image of the film obtained by shooting the object under test into gradation data of respective color components; a reference weight table storage for storing therein pre-measured reference values of the weight per unit area corresponding to gradation levels of at least one of the color components in the form of a table; and a calculator for obtaining a weight per unit area of the film of the object under test by referring to the weight per unit area reference values stored in the reference weight table storage, using the gradation data of the at least one color component, as lookup data, among the gradation data of the respective color components obtained by the image pickup section.

With the above arrangements, when non-contact measurement is conducted using the image pickup section of the film measuring device of measuring the thickness and the weight per unit area of the film of the object under test, which is formed by coating, vapor deposition, or the like on the film-like or sheet-like base member, for detection of a defective area, the image pickup section shoots the object under test to obtain the color image, converts the color tone of the acquired color image into gradation data of the respective color components, and outputs the gradation data. Also, the reference thickness table storage and the reference weight table storage store therein the pre-measured thickness reference values and the pre-measured weight per unit area reference values as plural sampling data, and the gradation data concerning at least one color component which is effective in measuring the thickness and the weight per unit area of the film corresponding to each other, in the form of tables, respectively.

The color component effective in measuring the thickness and the weight per unit area of the film is a color component that has a large contrast relative to the base member, and has a relatively large change in gradation level in estimated variation ranges for the thickness and the weight per unit area of the film. A monochromatic color component may be used. Alternatively, combination of plural color components may be used in the case where the plural color components show a remarkable change between plural regions within the aforementioned variation ranges. Further alternatively, the color component may be in the form of a composite signal obtained by combining a color-difference signal to a luminance signal, in place of the signals respectively representing the individual color components of RGB, or cyan (C), magenta (M), and yellow (Y).

Also, the calculator for calculating the thickness and the weight per unit area of the film reads out the thickness and the weight per unit area of the film corresponding to a targeted gradation level by referring to the reference thickness table and the reference weight table, using the gradation data of the at least one color component which is effective in measuring the thickness and the weight per unit area of the film among the gradation data of the respective color components obtained by the image pickup section. If, however, the data concerning the film thickness and the data concerning the weight per unit area corresponding to the targeted gradation level are not stored in the table storage, the calculator obtains data concerning the thickness and the weight per unit area of the film corresponding to the targeted gradation level, using the techniques such as approximation or data interpolation for the thickness and the weight per unit area of the film corresponding to the targeted gradation level, according to needs.

In the above arrangement, the thickness and the weight per unit area of the film can be accurately and easily measured. Also, selecting at least one color component which is effective in measuring the thickness and the weight per unit area of the film enables to measure the thickness and the weight per unit area of a film made of an intended material. Further, changing the image pickup position, or providing the image pickup position over the entire area of the object under test enables to measure the thickness and the weight per unit area of the film over the entire area thereof.

Preferably, each of the film measuring devices further includes an illumination light source for projecting illumination light onto the film of the object under test; an illuminance sensor for detecting an illuminance of the illumination light; and an illumination controller for feedback controlling the illumination light source so that the illuminance of the illumination light is made constant in accordance with the illuminance detected by the illuminance sensor.

With the above arrangement, the illuminance sensor detects the illuminance of the illumination light, which may be changed due to aging degradation of the illumination light source, or fluctuation of a power source voltage, and the illumination controller feedback controls the illumination light source so that the illuminance of the illumination light is made constant in accordance with the detected illuminance.

The above arrangement enables to maintain the illuminance of the illumination light constant, despite the aging degradation of the illumination light source or the fluctuation of the power source voltage, thereby allowing accurate measurement of the thickness and the weight per unit area of the film.

Preferably, in each of the film measuring devices, in the case where the base member of the object under test is made of a transparent or semitransparent material, the device further includes a background member having a contrast relative to the film, the background member being provided on a side opposite to the image pickup section with respect to the object under test.

With the above arrangement, in the case where the base member of the object under test is made of the transparent or semitransparent material, illumination light or ambient light irradiated from the side of the image pickup section may likely transmit through the object under test, if the laminated film has an unduly small thickness. In view of the likelihood, the background member having a contrast relative to the film is provided on the side opposite to the image pickup section with respect to the object under test. This enables to accurately measure the thickness and the weight per unit area of the film based on the gradation data of the at least one color component.

Preferably, the film measuring device of the first aspect further includes an input section for allowing an operator to input actually measured film thicknesses as the reference values corresponding to the gradation levels of the respective color components for storage into the reference thickness table storage.

With the above arrangement, allowing the operator to withdraw the object under test after the image pickup, and to input the actually measured film thickness data into the reference thickness table storage storing the pre-measured film thicknesses as the reference values enables to correct a calibration curve concerning a relationship between gradation levels of the respective color components, and coating amount, and to increase the number of the sampling data to thereby enhance measurement precision of the film thickness.

A coater according to another aspect of the present invention includes: the film measuring device having the image pickup section, the reference thickness table storage, and the calculator; a coating section for forming the film on the base member; and a coating amount controller for controlling a coating amount for the film in the coating section in accordance with the thickness of the film obtained by the calculator.

With the above arrangement, the coating amount can be automatically controlled in accordance with the film thickness measured by the film measuring device.

Preferably, in the coater, the calculator judges whether the obtained thickness of the film lies within an allowable range relative to a predetermined reference value, and detects a predetermined area on the film including an area where the thickness of the film is judged to lie out of the allowable range, as a defective area.

With the above arrangement, it is easy to detect the predetermined area on the film including the area where the thickness of the film is judged to lie out of the allowable range, as the defective area, which is appropriate for the actual process, as compared with a case that merely the area where the thickness of the film is judged to lie out of the allowable range is detected as the defective area.

As described above, the invention is advantageous in accurately and easily measuring the thickness and the weight per unit area of a film made of an intended material over an entire area thereof, automatically controlling the coating amount for the film of the object under test in accordance with the measured film thickness, and easily detecting the defective area of the film, wherein the object under test is composed of the laminated layers formed by coating, vapor deposition, or the like on the film-like or sheet-like base member.

This application is based on Japanese Patent Application No. 2005-254331 filed on Sep. 2, 2005, the contents of which are hereby incorporated by reference.

What is claimed is:

1. A film measuring device for measuring a physical amount of a film formed on a film-like or sheet-like base member of an object under test, the device comprising:
an image pickup section for converting a color tone of a color image of the film obtained by shooting the object under test into gradation data of respective color components;
a table storage for storing therein pre-measured reference values of the physical amount of the film corresponding to gradation levels of at least one of the color components in the form of a table; and
a calculator for obtaining the physical amount of the film of the object under test by referring to the reference values of the physical amount of the film stored in the table storage, using, as lookup data, the gradation data of the at least one color component among the gradation data of the respective color components obtained by the image pickup section.

2. The film measuring device according to claim 1, wherein
the physical amount of the film is a thickness of the film, and
the table storage stores therein the pre-measured reference values of the film thickness corresponding to the gradation levels of the respective color components, as reference thickness table data.

3. The film measuring device according to claim 1, wherein
the physical amount of the film is a weight per unit area of the film, and
the table storage stores therein the pre-measured reference values of the weight per unit area of the film corresponding to the gradation levels of the respective color components, as reference weight table data.

4. The film measuring device according to claim 1, further comprising:
an illumination light source for projecting illumination light onto the film;
an illuminance sensor for detecting an illuminance of the illumination light;- and
an illumination controller for feedback controlling the illumination light source so that the illuminance of the illumination light is made constant in accordance with the illuminance detected by the illuminance sensor.

5. The film measuring device according to claim 1, wherein in the case where the base member of the object under test is made of a transparent or semitransparent material, the device further comprises a background member having a contrast relative to the film, the background member being provided on a side opposite to the image pickup section with respect to the object under test.

6. The film measuring device according to claim 1, further comprising an input section for allowing an operator to input actually measured physical amounts as the reference values corresponding to the gradation levels of the respective color components for storage into the table storage.

7. A coater comprising:
the film measuring device recited in claim 1;
a coating section for forming the film on the base member; and
a coating amount controller for controlling a coating amount for the film in the coating section in accordance with the physical amount of the film obtained by the calculator of the film measuring device.

8. The coater according to claim 7, wherein
the calculator judges whether the obtained physical amount of the film lies within an allowable range relative to a predetermined reference value, and detects a predetermined area on the film including an area where the physical amount of the film is judged to lie out of the allowable range, as a defective area.

9. A film measuring method for measuring a physical amount of a film formed on a film-like or sheet-like base member of an object under test, the method comprising steps of:
converting a color tone of a color image of a film obtained by shooting the object under test into gradation data of respective color components; and
obtaining a physical amount of the film of the object under test by referring to pre-measured reference values of the physical amount of the film corresponding to the gradation data of at least one of the color components obtained in the conversion step, using the gradation data of the at least one color component as lookup data, the reference values being stored as table data.

10. The film measuring method according to claim 9, wherein
the physical amount of the film is a thickness of the film, and
the table data is reference thickness table data representing the pre-measured reference values of the film thickness stored corresponding to gradation levels of the respective color components.

11. The film measuring method according to claim 9, wherein
the physical amount of the film is a weight per unit area of the film, and
the table data is reference weight table data representing the pre-measured reference values of the weight per unit area of the film stored corresponding to gradation levels of the respective color components.

12. A coating method using the film measuring method of claim 9, comprising steps of:
forming the film on the base member; and
controlling a coating amount for the film in the coating step in accordance with the physical amount of the film obtained by the film measuring method.

13. The coating method according to claim 12, further comprising steps of:
judging whether the physical amount of the film obtained by the film measuring method lies within an allowable range relative to a predetermined reference value; and
detecting a predetermined area on the film including an area where the physical amount of the film is judged to lie out of the allowable range, as a defective area.
